(19) United States
(12) Patent Application Publication
(10) Pub. No.: US 2024/0201951 A1
(43) Pub. Date: Jun. 20, 2024

(54) SYSTEMS AND METHODS FOR SHIFT LAST MULTIPLICATION AND ACCUMULATION (MAC) PROCESS

(71) Applicant: Taiwan Semiconductor Manufacturing Company, Ltd., Hsinchu (TW)

(72) Inventors: Kinshuk Khare, Hsinchu (TW); Hidehiro Fujiwara, Hsinchu (TW); Wei-Chang Zhao, Hsinchu (TW); Haruki Mori, Hsinchu (TW)

(73) Assignee: Taiwan Semiconductor Manufacturing Company, Ltd., Hsinchu (TW)

(21) Appl. No.: 18/332,122

(22) Filed: Jun. 9, 2023

Related U.S. Application Data
(60) Provisional application No. 63/433,278, filed on Dec. 16, 2022.

(51) Int. Cl. G06F 7/544; G06F 5/01

(52) U.S. Cl. CPC G06F 7/5443; G06F 5/01

(57) ABSTRACT

A method for performing a shift last multiplication and accumulation (MAC) process. A processing circuit can multiply a first input by a first bit of a second input to obtain a first intermediate output. The processing circuit can multiply a third input by a first bit of a fourth input to obtain a second intermediate output. The processing circuit can sum the first and second intermediate outputs to obtain a first sum. The processing circuit can multiply the first input by a second bit of the second input to obtain a third intermediate output. The processing circuit can multiply the third input by a second bit of the fourth input to obtain a fourth intermediate output. The processing circuit can sum the third and fourth intermediate outputs to obtain a second sum. The processing circuit can generate an output by accumulating the first sum and the second sum.

### CROSS-REFERENCE TO RELATED APPLICATION

This application claims the benefit of and priority to U.S. Provisional Application No. 63/433,278, filed Dec. 16, 2022, titled “MULTIPLICATION AND ACCUMULATION (MAC) SHIFT ADD OF PARTIAL PRODUCT,” which is incorporated herein by reference in its entirety.

### BACKGROUND

An integrated circuit (IC) can contain a variety of hardware circuit devices or types of logic, including FPGAs, application-specific integrated circuits (ASICs), logic gates, registers, or transistors, in addition to various interconnections between the circuit devices. The IC can be manufactured using or composed of semiconductor materials, for instance, as part of electronic devices, such as computers, portable devices, smartphones, internet of thing (IoT) devices, etc. Developments and increasing complexity of the ICs have prompted increased demands for higher computational efficiency and speed. More specifically, the ICs can be configurable and/or programmable to perform computations in sequences or variations desired by the manufacturer, developer, technician, or programmer, among others.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates an example block diagram of a system to perform a shift last/later multiplication and accumulation (MAC) process, in accordance with some embodiments.

FIG. 2 illustrates an example block diagram of a process to compute a sum using a simplified carry lookahead adder (CLA) performed by the system of FIG. 1, in accordance with some embodiments.

FIG. 3 illustrates an example block diagram of a process to compute a sum using a simplified carry select adder (CSA) performed by the system of FIG. 1, in accordance with some embodiments.

FIG. 4 is an illustration of an example critical path for the shift last MAC process performed by the system of FIG. 1, in accordance with some embodiments.

FIG. 5 illustrates an example logic structure for accumulating partial products and performing shift and add to obtain an output for the shift last MAC process as in FIG. 4, in accordance with some embodiments.

FIG. 6 illustrates example calculation steps using the shift last MAC process performed by the system of FIG. 1, in accordance with some embodiments.

FIG. 7 is an example flow chart of a method for shift last MAC process performed by the system of FIG. 1, in accordance with some embodiments.

FIG. 8 illustrates an example of a summation using a simplified CSA and/or simplified CLA performed by the system of FIG. 1, in accordance with some embodiments.

FIG. 9 illustrates an example block diagram of a process to compute a sum between two binary numbers using the simplified CSA performed by the system of FIG. 1, in accordance with some embodiments.

FIG. 10 illustrates an example bit serial MAC using the simplified CSA performed by the system of FIG. 1, in accordance with some embodiments.

FIG. 11 illustrates an example bit parallel MAC using the simplified CSA performed by the system of FIG. 1, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over, or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

In general, the present disclosure provides a shift last multiplication and accumulation (MAC) approach for processing by a circuit (e.g., processing circuit or integrated circuit (IC)). The processing circuit can correspond to or be referred to as an IC. The processing circuit can include a variety of hardware circuit devices or types of logic, including FPGAs, digital signal processors (DSPs), application-specific integrated circuits (ASICs), logic gates, registers, or transistors, in addition to various interconnections between the circuit devices. The processing circuit can be configured, structured, or programmed to execute/perform/initiate logic operations, such as the MAC operation/process.

In certain systems, a MAC process involves multiplying two numbers (e.g., a set/term of numbers) to obtain a product and adding the product to an accumulator. The two numbers can be referred to as two inputs, each represented by a number of bits (e.g., 4 bits, 8 bits, 16 bits, 32 bits, 64 bits, etc.). The process of multiplying two numbers and adding the product to the accumulator is repeated according to the sets/terms of numbers to be multiplied, each set of numbers including two respective numbers. However, during the MAC process of these systems, the shift and add operations or logic are performed during the multiplication step (e.g., shift and add first). For example, these systems perform the shift and add operations to add all the partial products (PP) generated by the multiplication of a respective set of numbers and the product of each set of numbers are accumulated via the accumulator. Because the shift and add operations are performed first (e.g., sometimes referred to as “shift first” operation), these systems are not able to utilize fast adders considering ripple carry adders are used in later stages/steps of the MAC process. In particular, ripple carry adder includes carry propagation from the least significant bit (LSB) to the most significant bit (MSB), and a critical path (e.g., maximum delay path in a logic circuit) travels or traverses from the later stage adder LSB to MSB. Hence, with the shift first operation, fast adders may not be utilized when performing the MAC process, resulting in excessive power consumption, computing speed reduction, and extra transistors being utilized/configured for the MAC process.

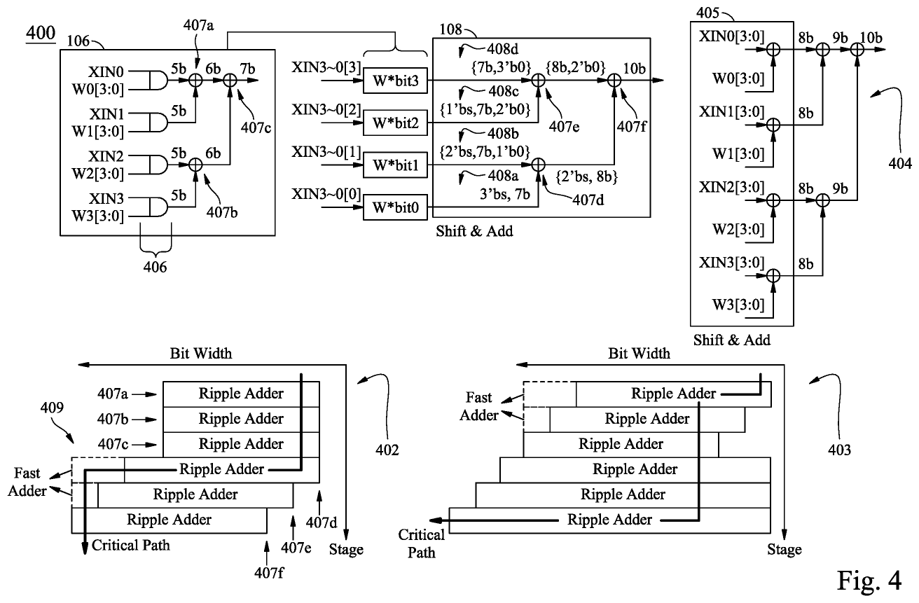

The systems and methods of the technical solution discussed herein can perform the MAC process by performing the shift operation at a later stage (e.g., “shift last” or “shift later” operation) relative to the shift first operation. For example, the systems and methods can perform the multiplication steps between multiple sets of two numbers without performing the shift and add operations. In this case, the systems and methods can obtain/collect the partial products of the sets of two numbers. These partial products can be associated with an order/position of bit used to obtain the respective partial product, e.g., from the LSB to the MSB, bit position 0, bit position 1, bit position 2, etc. The systems and methods can sum the partial products associated with the same bit position to obtain multiple sums of partial products. Accordingly, the systems and methods can perform the shift and add operations on the sums of the partial products at the last or later stage of the MAC process using fast adders (e.g., simplified carry select adder (CSA) or simplified carry-lookahead adder (CLA)) to obtain an output of the MAC process. For example, fast adders can be used in the shift and add operations. As described in conjunction with but not limited to FIG. 4, because adders in later stages of the MAC operation are ripple carry adders, which have carry propagation from LSB to MSB and the critical path (e.g., maximum delay path) traveling from the later stage adder LSB to MSB, performing a shift and add operation in later stages of the MAC process (e.g., instead of in early stages, such as in shift first operation) using the fast adders can reduce the carry propagation delay (or minimize the critical path) otherwise caused by performing the shift operation first in the MAC operation, for example. By utilizing shift last operation and fast adders, the systems and methods can minimize/reduce power consumption, enhance/increase computing speed, and reduce the number of transistors utilized for the MAC process.

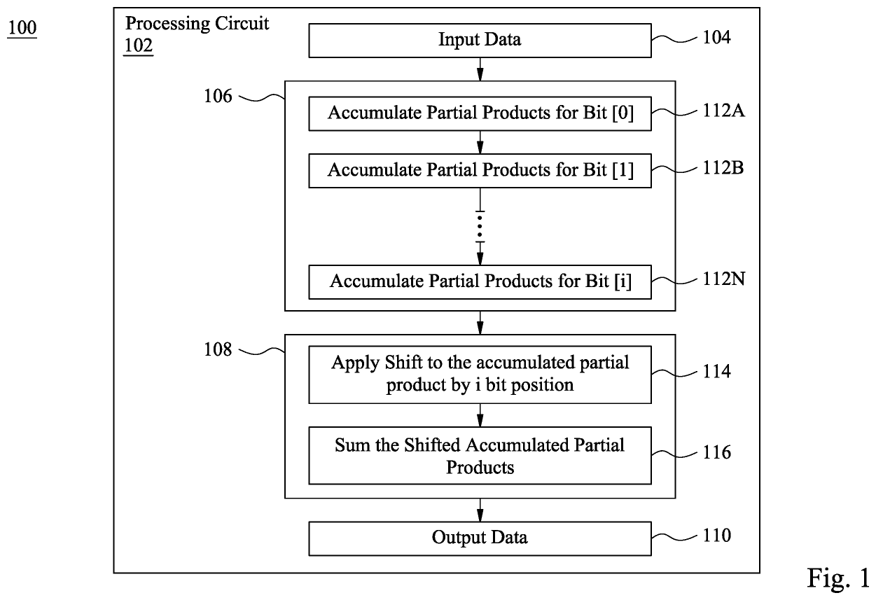

Referring now to FIG. 1, depicted is an example block diagram of a system 100 to perform a shift last MAC process, in accordance with some embodiments. The system 100 may correspond to an electronic device operated/used by an operator. The system 100 includes at least one processing circuit 102, among other circuits. The processing circuit 102 can include or correspond to an IC or a logic device including (reconfigurable) digital circuits. The processing circuit 102 may be composed of semiconductor materials. The processing circuit 102 includes a variety of hardware circuit devices or types of logic, such as FPGAs, DSPs, ASICs, logic gates, multiplexers, registers, or transistors. The circuit devices of the processing circuit 102 are electrically or communicatively coupled/connected via various interconnections between the circuit devices. In various implementations, the processing circuit 102 utilizes various hardware circuit devices (e.g., logic gates, multiplexers, registers, etc.) to perform logic operations, such as adding, subtracting, dividing, multiplying, etc. For simplicity, and for purposes of providing examples herein, the processing circuit 102 can be a (programmable) logic device including various logic gates configured/structured to perform the shift last MAC process.

The processing circuit 102 includes various registers configured to store or hold binary information (e.g., bits representing signed or unsigned numbers). The registers may receive binary information via signals from one or more other circuits within the system 100, e.g., responsive to inputs from the operator/user of the system 100). In some cases, the registers may receive binary information from other devices in communication with the system 100 or the processing circuit 102. The components (e.g., circuit devices or logic components) of the processing circuit 102 can receive signals from the registers representing the binary information for processing. The signals from the registers can traverse the logic components of the processing circuit 102, such that logic operations (e.g., addition, multiplication, shift, etc.) can be performed using the binary information. Responsive to the signals traversing the logic components, the processing circuit 102 can generate a signal representing an output of the logic operations discussed herein (e.g., results of the MAC process/operation).

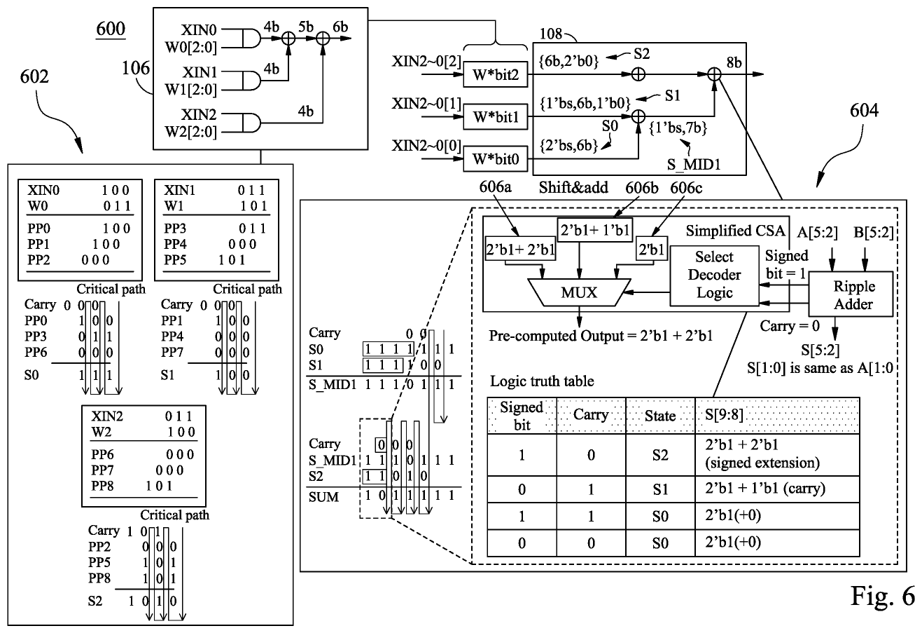

In various implementations, the processing circuit 102 can include a predetermined number of registers. The binary information stored in the registers can correspond to the inputs (e.g., groups of bits) for the MAC process, for example, as part of the input data 104. The MAC process can be represented via the following formula: OUT=Σⱼ₌₀ⁱXINⱼ*Wj=XINi*Wi+XIN₍ᵢ₋₁₎*W₍ᵢ₋₁₎+ . . . +XIN₀*W₀. The OUT represents the output (e.g., output data 110) from the processing circuit 102 responsive to performing the MAC process. The XIN and the W (e.g., weight) can represent the inputs to be multiplied and accumulated. The j represents the total sets, groups, or pairs of bits (e.g., binary numbers) to be multiplied and accumulated. The i represents the respective groups of bits (e.g., XIN and W) to be multiplied and accumulated with other groups of bits, for example. Each group of bits can be a group of 2-bits, 3-bits, 4-bits, 6-bits, 8-bits, etc. In the shift last MAC process discussed herein, the processing circuit 102 can be configured to obtain the partial products (e.g., PP0-8 described in conjunction with FIG. 6) from different i terms (e.g., different groups of inputs) to generate or compute a sum of partial products associated with a certain order of bit, such that a shift and add operations on the partial products can be performed in later stages, thereby enabling fast adder for signed extension summation. For example, as described in conjunction with, but not limited to, FIG. 6, partial products of XIN0-2 and W0-2 can be computed, including PP0-PP8. The partial products PP0, PP3, and PP6 can be added to obtain a first sum of partial products associated with a first bit order (e.g., S0), partial products PP1, PP4, and PP7 can be added to obtain a second sum of partial products associated with a second bit order (e.g., S1, shifted by 1 bit position), and partial products PP2, PP5, and PP8 can be added to obtain a third sum of partial products associated with a third bit order (e.g., S2, shifted by 2 bit positions).

For example, a first register can store a first input (e.g., number represented by a group of bits), a second register can store a second input, a third register can store a third input, a fourth register can store a fourth input, etc. To perform the MAC process, one input can be associated with another input for the multiplication operation, such as the first input and the second input, the third input and the fourth input, etc. These two inputs can be referred to as a pair of inputs. In certain systems that perform the shift first MAC process, each pair of inputs are multiplied and accumulated with other multiplied pairs of inputs to obtain an output. However, by performing shift operations during the multiplication stage (e.g., in the shift first MAC process), fast adders may not be used in later stages of the MAC process.

To perform the shift last MAC process, as an initial step, the processing circuit 102 can determine, compute, or obtain partial products of various pairs of inputs. Each partial product can be referred to as an intermediate output. For example, a pair of inputs can include XIN and W, where each pair can be used to compute the partial products, such as partial products PP0-8, as described in conjunction with FIG. 6. The computation between two inputs (e.g., bits or numbers) can be via signals propagation from the registers through various logic gates. The logic gates can include AND gates, OR gates, XOR gates, etc. The various logic gates can be configured, programmed, or arranged to perform addition operations, multiplication operations, or other types of operations. For example, as described in conjunction with but not limited to FIG. 4, at least one of an AND gate (e.g., AND logic gate 406) and/or an OR gate can be used for the multiplication and/or addition between two binary numbers. For simplicity, and for purposes of providing examples herein, the processing circuit 102 can perform the shift last MAC process on two pairs of inputs. A first pair of inputs can include a first input and a second input. A second pair of inputs can include a third input and a fourth input.

For example, the processing circuit 102 can compute partial products between the first input and the second input (e.g., first pair) by multiplying the first input by each bit of the second input (or vice versa). The processing circuit 102 can compute partial products between the third input and the fourth input (e.g., second pair) by multiplying the third input by each bit of the fourth input (or vice versa). For instance, when described in conjunction with but not limited to FIG. 6, the first input may be XIN0, the second input may be W0, the third input may be XIN1, and the fourth input may be W1. The number of partial products depends on the number of bits associated with each input. In the case of FIG. 6, for example, multiplication between 3-bit binary numbers can result in three partial products, such as PP0-2 as the partial products of XIN0 and W0, and PP3-5 as the partial products of XIN1 and W1. Each bit used to obtain the partial product can be associated with an order/position/index of bits, e.g., from LSB to MSB. For example, the inputs can be 3-bit inputs. To compute the partial products of the first pair, as referred to in FIG. 6 for example, the processing circuit 102 multiplies the first input by a first bit of the second input at bit index [0] (e.g., XIN0 multiplied by W0[0]), multiplies the first input by a second bit of the second input at bit index [1] (e.g., XIN0multiplied by W0[1]), and multiplies the first input by a third bit of the second input at bit index [2] (e.g., XIN0 multiplied by W0[2]), etc. The processing circuit 102 can perform similar processes/operations to obtain the partial products of the second pair of inputs. In some cases, the processing circuit 102 can store the partial products in individual registers or in at least one memory device. As discussed herein, the input data 104 can include the partial products computed for individual pairs of inputs.

The processing circuit 102 can include block 106 (e.g., first block) and block 108 (e.g., second block) configured to perform logic operations for the shift last MAC process. The processing circuit 102 can feed the input data 104 to block 106 and/or block 108. Each of the blocks (e.g., block 106 or block 108) may correspond to or represent respective logic components, circuit devices, or process blocks. For example, in brief overview, block 106 can include logic components configured to accumulate partial products associated with the same bit order/index/position (e.g., in reference to, but not limited to FIG. 6, accumulating PP0, PP3, and PP6 associated with the same bit order, accumulating PP1, PP4, and PP7 associated with the same bit order, and accumulating PP2, PP5, and PP8 associated with the same bit order) used to compute the respective partial products. Block 108 can include logic components configured to apply a shift operation (e.g., shifting the sum of the partial products by one or more bit positions according to the bit position of W used to obtain the corresponding partial products, such as shifting S1 by one bit position or shifting S2 by two bit positions, as described in conjunction with at least FIG. 6) and add the shifted bits (e.g., adding S0 by S1, where S1 is shifted, and adding S_MID1 by S2, where S2 is shifted, as described in conjunction with at least FIG. 6) to generate an output (e.g., output data 110) of the shift last MAC process (e.g., in the case of FIG. 6, to generate the sum of S0, S1, and S2). In some implementations, the input data 104 fed to block 106 can include the inputs XIN and W to be used for computing the partial products. In this case, block 106 can include features or functionalities for computing the partial products and for accumulating these partial products. In some other implementations, the input data 104 fed to block 106 can include the partial products computed from the XIN and W (e.g., input pair), for example.

In block 106, the processing circuit 102 can accumulate the partial products according to the bit order/position/index of one of the inputs (of the pair of inputs) used to calculate the respective partial products (operations 112A-N). For example, the processing circuit 102 can identify the first partial products (e.g., first group of partial products, such as PP0, PP3, and PP6 from W0-2 respectively in FIG. 6) computed using a bit order [0] (e.g., bit position [0] from W0-2 in FIG. 6) from one of the inputs (e.g., multiplier, multiplicand, or factor). The processing circuit 102 can identify the second partial products (e.g., second group of partial products, such as PP1, PP4, and PP7 from W0-2 respectively in FIG. 6) computed using the bit order [1] (e.g., bit position [1] from W0-2 in FIG. 6) from one of the inputs. The processing circuit 102 can identify the third partial products (e.g., third group of partial products) computed using the bit order [2] from one of the inputs. The processing circuit 102 can identify other groups or sets of partial products computed using other orders of bit from one of the inputs.

The processing circuit 102 can accumulate (e.g., sum or add) the partial products according to their associated bit order. For example, the processing circuit 102 can sum the first partial products (e.g., PP0, PP3, and PP6, as in FIG. 6) associated with the bit order [0]. The processing circuit 102 can sum the second partial products (e.g., PP1, PP4, and PP7, as in FIG. 6) associated with the bit order [1]. The processing circuit 102 can sum the third partial products (e.g., PP2, PP5, and PP8, as in FIG. 6) associated with the bit order [2]. The processing circuit 102 can sum other partial products associated with each respective bit order. Responsive accumulating (e.g., summing) each group of partial products based on or according to the bit order, the processing circuit 102 can provide the sums of the partial products (e.g., S0, S1, and S2 can be provided from block 106) to block 108, e.g., to perform the shift (e.g., shift last) and add operations for the shift last MAC process. In the case of, but not limited to, FIG. 6, the shift operation can be performed on S1 (e.g., shift by one bit position) and S2 (e.g., shift by two bit positions) based on the bit position used to compute the respective partial products (e.g., bit [0], bit [1], or bit [2] of W or XIN, depending on the configuration).

In block 108, the processing circuit 102 can identify each sum of partial products associated with a respective bit order, such as bit order [0], bit order [1], bit order [2], etc. The sum of partial products associated with each bit order may sometime be referred to generally as a sum, such as a first sum, a second sum, a third sum, etc., from LSB to the MSB of the bit order. For example, the sum of partial products associated with bit order [0] (e.g., bit order [0] used to compute the partial products of respective pairs of inputs) may be referred to as a first sum (e.g., S0 in FIG. 6), the sum of partial products associated with bit order [1] may be referred to as a second sum (e.g., S1 in FIG. 6), the sum of partial products associated with bit order [2] may be referred to as a third sum (e.g., S2 in FIG. 6), etc.

The processing circuit 102 can shift (e.g., apply a shift operation to) the sum of or accumulated partial products according to the bit order associated with each respective sum (operation 114). For example, as described in conjunction with but not limited to FIG. 6, for the accumulated partial product S0, the processing circuit 102 does not perform the shift because the bit position of either W or XIN used to compute the corresponding partial products is bit position [0]. For the accumulated partial product S1, the processing circuit 102 performs the shift operation by 1 bit position because the bit position of either W or XIN used to compute the corresponding partial products is bit position [1]. For the accumulated partial product S2, the processing circuit 102 performs the shift operation by 2 bit position because the bit position of either W or XIN used to compute the corresponding partial products is bit position [2], for example. The processing circuit 102 can insert, include, or add at least one bit ‘0’ to the LSB position of the bits (e.g., binary number) according to the bit order or the number of bit position shifts. For example, the processing circuit 102 may not shift the first sum (e.g., S0 of FIG. 6, among others) associated with the bit order [0]. The processing circuit 102 can shift the second sum (e.g., S1 of FIG. 6, among others) associated with the bit order [1] by one bit (e.g., shift left by one bit position/index/order). The processing circuit 102 can add bit ‘0’ to the LSB of the (shifted) second sum. The processing circuit 102 can shift the third sum (e.g., S2 of FIG. 6, among others) associated with the bit order [2] by two bits (e.g., shift left by two bit positions), adding bits ‘00’ to the LSB of the (shifted) third sum, etc. The processing circuit 102 can apply a shift to other sums of the partial products according to the bit order associated with the respective sums.

Subsequent to shifting at least one of the sums of partial products, the processing circuit 102 can add or sum the summed/accumulated partial products (operation 116), such as accumulating partial products PP0-8 as in, but not limited to, FIG. 6, for example. For example, the processing circuit 102 can add the first sum (e.g., no shift) to the second sum (e.g., shift left by one bit position) to obtain an initial output data of the summation. The processing circuit 102 can add the first result to the third sum (e.g., shift left by two bit positions) to obtain updated/accumulated output data of the summation. The processing circuit 102 can add other sums of the partial products to obtain output data 110 for the shift last MAC process. In some cases, the processing circuit 102 may add multiple sums of partial products in any order, such as adding the first sum to the third sum, adding the second sum to a fourth sum, etc. By accumulating/summing/adding the sums of the partial products, the processing circuit 102 can generate or obtain the output data 110 (e.g., a result) of the shift last MAC process.

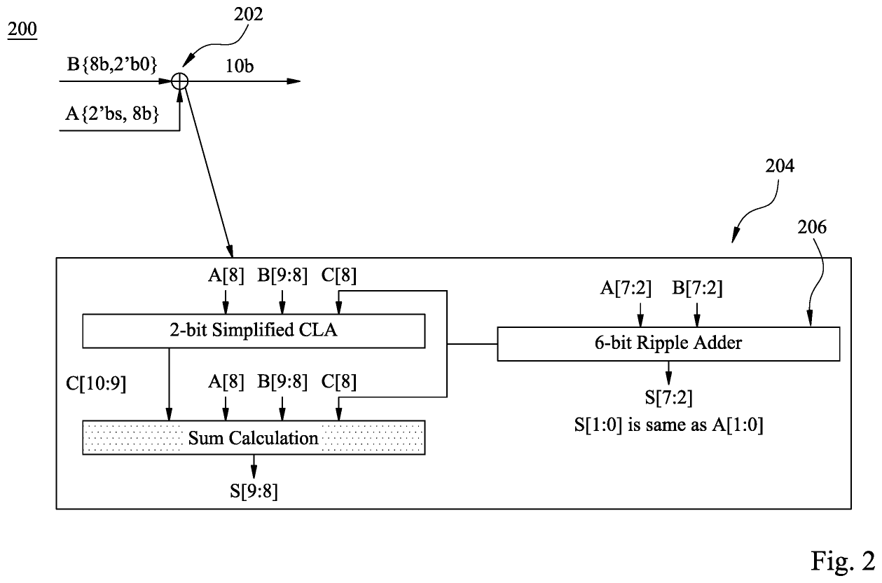

In some implementations, the processing circuit 102 may sequentially perform a shift and add operations to each pair of the sums of partial products. For example, the processing circuit 102 can shift the second sum by one bit position to the left. The processing circuit 102 can add the first sum to the shifted second sum to obtain an initial/first output. Subsequently, the processing circuit 102 can shift the third sum by two-bit positions to the left. The processing circuit 102 can add the initial output (e.g., sum of the first sum and the second sum) to the shifted third sum to obtain a second output. The processing circuit 102 can repeat this process for any remaining sums of partial products to obtain the output data 110. In various configurations, the shift last MAC process/operation (performed by the processing circuit 102) can be referred to or described in further detail herein, for instance, in conjunction with at least one of FIGS. 2-7.

Referring to FIG. 2, depicted is an example block diagram of a process 200 to compute a sum using a simplified carry lookahead adder (CLA), in accordance with some embodiments. In various implementations, the process 200 can be performed or implemented using any of the components, devices, or circuits detailed herein in conjunction with FIG. 1, such as the processing circuit 102 of the system 100, among others. In various other implementations, the process 200 can be performed by other components or devices thereof, not limited to FIG. 1. The process 200 can be performed herein to generate a sum of binary numbers using a simplified CLA. The process 200 includes a summation operation 202 between two inputs (binary numbers, variables, or values) using a fast adder, such as simplified CLA in this example. Block 204 shows example logic components or digital circuits configured to perform simplified CLA for two 10-bit inputs. As shown, the inputs A and B of operation 202 can correspond to the inputs provided in block 204. Although the inputs include 10-bits in this case, the operation 202 can be performed on inputs with other numbers of bits, such as 4-bits, 8 bits, 16 bits, etc.

For example, the processing circuit 102 can perform the summation between inputs (e.g., adding partial products associated with a respective bit order or adding accumulated partial products) using the CLA as the fast adder. The summation using the CLA can be performed before the shift operation, such as before shifting (e.g., shifting the bit position of the binary number) the accumulated partial products. In this case, the input A includes 8 bits and 2 signed bit extension (e.g., a total of 10 bits), and the input B includes 8 bits shifted by 2 bit positions (e.g., a total of 10 bits). Because of the 2 bit shift (e.g., ‘00’ at the end of the 8 bits of input B), the first two bits for the sum of A and B (e.g., S[1:0]) is the same as A[1:0], because of A[1:0]+‘00’=A[1:0], for example. Hence, the processing circuit 102 can (e.g., directly) use A[1:0] as the resulting S[1:0]. The processing circuit 102 can use the ripple adder (e.g., ripple adder 206) to add A[7:2] and B[7:2]. The results from the ripple adder 206 can include S[7:2] and a carry bit C[8]. The processing circuit 102 can feed the signed extension bit(s) of the input A, the corresponding bits from input B (e.g., bits having the same bit positions as the signed extension bits), and the carry bit C[8] to the simplified CLA. The processing circuit 102 can compute these bits using the simplified CLA to determine S[9:8], which can be linked to S[7:2] from the ripple adder 206 and S[1:0] corresponding to A[1:0]. The output of block 204 (e.g., S[9:0]) can correspond to the output of the operation 202.

In various configurations, the processing circuit 102 can use one or more fast adders discussed herein to perform signed extension summation for the shift last MAC process, e.g., to reduce carry propagation delay because all signed extension bits are the same as the MSB of the respective binary number. In the case of FIG. 2, the simplified CLA is used as the fast adder, although other fast adders may be used in later stages of the MAC process. The ripple carry adders discussed herein can correspond to a digital circuit configured to generate/produce the sum of two binary numbers. For example, the ripple carry adder is implemented/constructed with full adders connected in cascade (e.g., ripple carry adder can be used to sum two binary numbers as discussed herein). The number of full adders corresponds to the number of bits of the binary number inputs. For instance, two full adders can be used for summing two-bit binary numbers, three full adders can be used for summing three-bit binary numbers, etc. In operation, the carry-out of each full adder is the carry in of the succeeding next most significant full adder. Each carry bit is rippled into the next stage of the ripple carry adder. When provided with two inputs of binary numbers (e.g., inputs A and B provided to the ripple adder 206), the ripple carry adder can compute the sum of each bit position from LSB to MSB, rippling the carry bit of the sum to the next MSB, for example. The process of the ripple carry adder can be repeated until all bit positions (e.g., from LSB to MSB) have been summed. Although ripple carry adders may be used as examples herein, for example, other types of adders may be implemented in the processing circuit 102 to execute the shift last MAC process. As discussed herein, the ripple carry adders can be used to sum at least a portion of the binary numbers that are not corresponding to the signed extension bits, such as at least bits [7:2] of inputs A and B of FIG. 2, for example, because the simplified CLA is used, in this case, for summation of the signed extension bits.

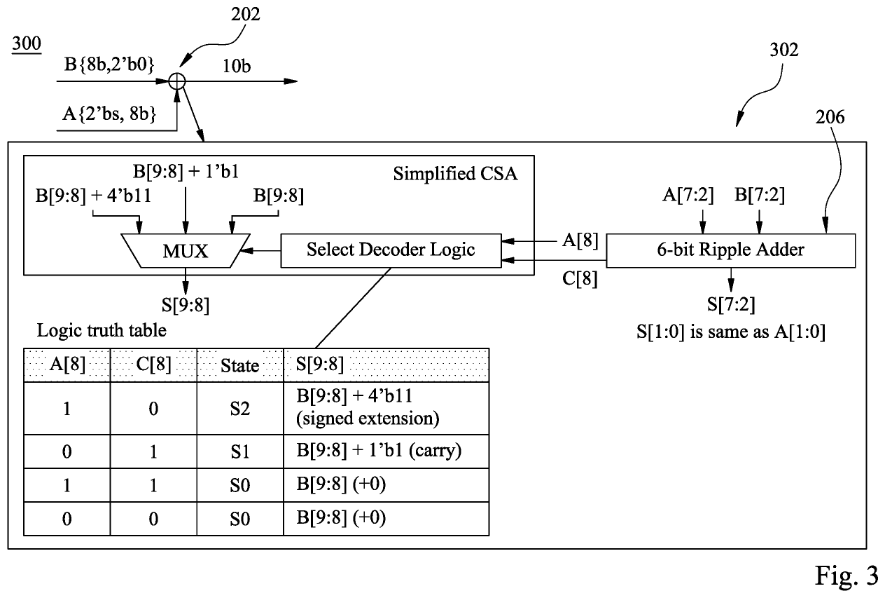

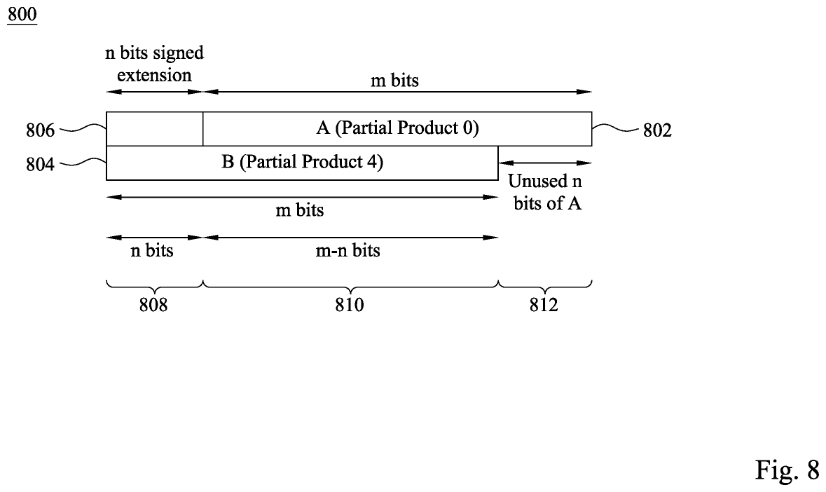

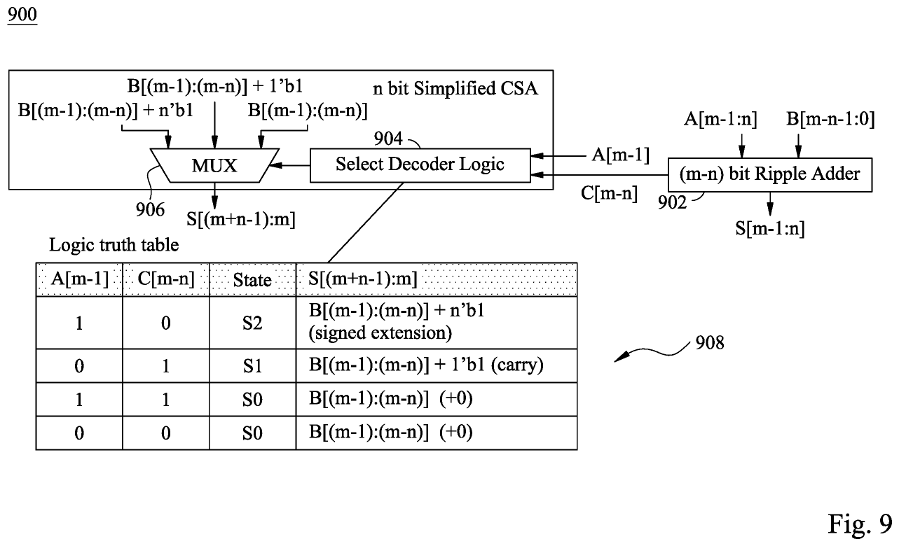

Referring to FIG. 3, depicted is an example block diagram of a process 300 to compute a sum using a simplified carry select adder (CSA), in accordance with some embodiments. In various implementations, the process 300 can be performed or implemented using any of the components, devices, or circuits detailed herein in conjunction with FIG. 1, such as the processing circuit 102 of the system 100, among others. In various other implementations, the process 300 can be performed by other components or devices thereof, not limited to FIG. 1. The process 300 can be performed herein to generate a sum of binary numbers using a simplified CSA. The process 300 can be used in conjunction with or instead of the process 200 to perform a summation between binary numbers, for example. The simplified CLA of process 200 and the simplified CSA of process 300 can be used to sum, for example, the signed extension of the input A and the corresponding bit positions of input B, such as the summation of but not limited to portion 808 of FIG. 8. As shown, compared to the simplified CLA of FIG. 2 which uses the carry bit from the ripple adder 206 for summation including determining the carry bit of the output, the simplified CSA of FIG. 3 uses the carry bit from the ripple 206 and the MSB (or signed extension bit) of the input A for selecting one of the inputs of the MUX, including predetermined computational methods according to the logic truth table. In some cases, the predetermined computational methods of the logic truth table may be pre-computed, such as described in but not limited to at least process 900 of FIG. 9.

The process 300 includes the summation operation 202 between two inputs using simplified CSA as the fast adder, in this example. Block 302 shows example logic components or digital circuits configured to perform simplified CSA for two 10-bit inputs. The inputs A and B of the operation 202 can correspond to at least a portion of the inputs in block 302 (e.g., A[7:2] and B[7:2] for the ripple adder 206, B[9:8] for the simplified CSA, and A[1:0] as the two LSB of the sum S[1:0]). For example, similarly to block 204, the first two LSB output from block 302 (e.g., S[1:0]) can correspond to A[1:0], and the ripple adder 206 can be used to add A[7:2] and B[7:2] to obtain S[7:2]. In this case, the processing circuit 102 can use the carry bit from the ripple adder 206 and the signed extension bit (e.g., ‘1’ or ‘0’) of the input A for the select decoder logic of the simplified CSA. The select decoder logic is coupled to a MUX to select at least one of the predetermined computational methods according to the logic truth table. For instance, if the signed bit (e.g., A[8] in this example) is 1 and the carry bit is 0, the select decoder logic can select B[9:8]+4′b11 for computing S[9:8] (e.g., the resulting two MSB). If the signed bit is 0 and the carry bit is 1, the select decoder logic can select B[9:8]+1′b1. If the signed bit is 0 and the carry bit is 0 or if the signed bit is 1 and the carry bit is 1, the select decoder logic can select B[9:8] (+0). By combining the S[9:8], S[7:2], and S[1:0] output from block 302, the processing circuit 102 can obtain the sum of the inputs A and B at operation 202. In some implementations, the processes of using the simplified CSA and/or the simplified CLA can be described in conjunction with at least one of FIGS. 8-11, for example.

In various implementations, the processing circuit 102 can utilize the simplified CSA, among other fast adders, similarly to the simplified CLA. For example, the processing circuit 102 can perform the summation between inputs using the CSA as the fast adder. The summation using the CSA can be performed before the shift operation, such as before shifting the accumulated partial products to reduce carry propagation delay considering all signed extension bits are the same as the MSB of the respective binary number. As described above, the CSA can be used for selecting a predetermined operation to compute the sum of a binary number and the signed extension of another binary number (e.g., signed extension bits of A and corresponding bits of B).

Referring to FIG. 4, depicted is an illustration 400 of an example critical path for the shift last MAC process, in accordance with some embodiments. The shift last MAC process performed to achieve the critical path (e.g., maximum delay path) of graph 402 can be implemented using any of the components, devices, or circuits detailed herein in conjunction with FIG. 1, such as the processing circuit 102 of system 100, among others. In various other implementations, the shift last MAC process can be performed by other components or devices thereof, not limited to FIG. 1. In example illustration 400, at block 106, the registers can store 4-bit inputs (or other number of bits), including XIN3 to XIN0 and W3 to W0. The processing circuit 102 can multiply individual bits of XIN3 to XIN0 with the bits (e.g., all [3:0] bits) of W3 to W0, for example, via the AND logic gate 406. For example, bit[0] of XIN3 to XIN0 can be multiplied with all bits of the respective W3 to W0, bit[1] of XIN3 to XIN0 can be multiplied with all bits of the respective W3 to W0, etc. The processing circuit 102 can perform the multiplications via the add logic gates. Responsive to multiplying individual bits of XIN3 to XIN0, the processing circuit 102 can produce the 5-bit partial products.

Still referring to block 106, with respective the bit order of all XIN used for multiplying with the respective W3 to W0, the processing circuit 102 can accumulate the partial products (e.g., partial products computed from the AND logic gate 406, and accumulated via ripple adders 407a-c) to generate 7-bit sums of partial products (sometimes referred to as partial product sums) of all XIN. For example, for bit order [0] of all XIN used to multiply with all bits of each W (e.g., bits [3:0] of W0, bits [3:0] of W1, bits [3:0] of W2, bits [3:0] of W3, etc.), the processing circuit 102 can generate four 5-bit partial products (e.g., first, second, third, and fourth partial products). In association with FIG. 1, the processing circuit 102 can accumulate the partial products via ripple adders 407a-c in block 106 to generate the sum of (or accumulated) partial products. In this example, the processing circuit 102 (e.g., described in conjunction with but not limited to block 106) adds the first partial product with the second partial product (e.g., at ripple adder 407a) to generate a first 6-bit intermediate partial product sum for bit order [0]. The processing circuit 102 adds the third partial product and the fourth partial product (e.g., at ripple adder 407b) to generate a second 6-bit intermediate partial product sum for bit order [0]. The processing circuit 102 adds the first and second 6-bit intermediate partial product sums (e.g., at ripple adder 407c) to generate/produce the 7-bit partial product sum (e.g., sometimes referred to as intermediate output) for bit order [0]. The processing circuit 102 can perform similar processes/operations/steps for other XIN bit orders used to obtain the partial products.

After generating the partial product sums (e.g., inputs to block 108), including four 7-bit partial product sums (e.g., 408a-d, each associated with a respective one of bit order [0] to bit order [3]), the processing circuit 102 can apply the shift (e.g., left shift) and add operations at block 108. As shown in block 108 of the example illustration 400, the processing circuit 102 applies a shift by one bit position for the partial product sum associated with bit order [1] (e.g., partial product sum 408b), two bit positions for partial product sum associated with bit order [2] (e.g., partial product sum 408c), and three bit positions for partial product sum associated with bit order [3] (e.g., partial product sum 408d). The processing circuit 102 may not apply a shift to the partial product sum associated with bit order [0] (e.g., partial product sum 408a). When applying the shift, bit ‘0’ can be added to the LSB position(s). The MSB position(s) of the partial product sums can include the signed bit or repeat(s) of the MSB of the partial product sums. In some cases, the signed extension can be denoted as x′bs (e.g., the ‘s’ representing ‘0’ or ‘1’ bit corresponding to the signed bit or MSB of partial product, repeated x number of times) and the unused bits can be denoted as y′b0 (unused bit y times).

Still referring to block 108, the four 7-bit partial product sums can be referred to as a first sum, a second sum, a third sum, and a fourth sum, associated with bit order [0] to [3], respectively. For example, the second, third, and fourth sum can be shifted by one, two, and three bit positions, respectively. To perform the shift and add operations, for example, the processing circuit 102 can add the first sum to the shifted second sum to generate a first 8-bit sum. The processing circuit 102 can add the shifted third sum to the shifted fourth sum to generate a second 8-bit sum. The processing circuit 102 can add the first 8-bit sum and the second 8-bit sum to generate a 10-bit output. For instance, the addition of the first 8-bit sum and the second 8-bit sum is two's complement, hence, the carry can be disregarded (e.g., the signed bit is accounted for via signed extension) to generate the 10-bit output. By performing the shift at the later/last stage, the processing circuit 102 can utilize fast adders for MAC process.

Referring to graph 402, the use of ripple adders (e.g., ripple carry adders) in various stages of the shift last MAC process can be described in conjunction with, but are not limited to, the operations of blocks 106 and 108. For example, the ripple adders 407a-c can be used in block 106 for summing the partial products. The ripple adders 407d-f can be used in block 108 for summing the sums of the partial products. In some implementations, the ripple adder 407a-f of graph 402, and/or blocks 106 or 108 can correspond to or be similar to the ripple adder of blocks 204 and/or 302, for example. The bit width of graph 402 can represent the size/number of bits when performing the ripple carry adders. For instance, for ripple adders 407a-c, there may be a maximum bit width of 7 bits. In another example, for ripple adders 407d-f, there may be a maximum bit width of 10 bits. The stages can represent the sequence of ripple adder operations performed in the shift last MAC process. For example, the processing circuit 102 can use the first three ripple adders (in the first three stages) to accumulate the partial products for a respective bit order (e.g., W*bit0, W*bit1, W*bit2, W*bit3, etc.), such as ripple adder 407a for accumulating the results of W*bit0 and W*bit1, ripple adder 407b for accumulating the results of W*bit2 and W*bit3, and ripple adder 407c for accumulating the results of the ripple adders 407a-b. There are three ripple adders at these stages (e.g., corresponding to block 106) because there are 4 inputs (e.g., inputs 1 and 2 can be added using a first ripple adder, inputs 3 and 4 can be added using a second ripple adder, and the sums of the first and second ripple adders can be added using a third ripple adder).

The processing circuit 102 can use the last three ripple adders (e.g., ripple adders 407d-f in the last three stages) to perform the shift and add operations of block 108 to obtain the output data 110. For example, the processing circuit 102 can use ripple adder 407d to accumulate the results from XIN3-0[0]*W and XIN3-0[1]*W, ripple adder 407e to accumulate the results from XIN3-0[2]*W and XIN3-0[3]*W, and ripple adder 407f to accumulate the results from the ripple adders 407d-e. At least one of the ripple adders 407d-f can take advantage of the fast adders to perform the shift and add operation, as in block 108. In some cases, the processing circuit 102 can perform fast adders 409 (e.g., performed in conjunction with at least one of ripple adders 407d-f) for the shift and add operations. The fast adders 409 may refer to or include at least one of the simplified CLA or the simplified CSA, among others, used with the ripple adders 407 (or ripple adder 206). As shown, by performing the shift and add operations at later stages of the MAC process, e.g., as opposed to earlier stages (in first shift MAC process), the fast adders 409 can be used, thereby increasing the computation speed, reducing power consumption (of electronic devices configured with the processing circuit 102), and/or decreasing logic components utilized within the circuitry to produce/generate the output data 110.

Because the signed bits are the same, the output data can be precomputed, for instance, without having to wait for the carry generation from the previous stage. In such cases, a parallel operation can be performed between the precomputation of the output data and the generation of the carry, such as described in conjunction with, but not limited to, FIGS. 2-3.

Referring to graph 403, associated with an example structure 404, the first three ripple adders can be used to shift and add (e.g., in the first three stages/steps of the shift and add operations) the various inputs (e.g., XINs) and the weights (e.g., “W”), such as described in conjunction with block 405. At the later stage(s) of graph 403, after performing the shift and add operations of the block 405 in this example, three ripple adders can be used to accumulate the data. For example, in the example structure 404, these later stages can include accumulating the 8-bit data from the shift and add operations of XIN and weights to form 9-bit data and accumulating the 9-bit data to form 10-bit data. As shown in graph 403, the critical path (e.g., max delay path or the longest propagation delay path) may not traverse via/through the fast adders of the shift and add stages in this case. Instead, graph 403 shows that the critical path traverses the ripple carry adder of the accumulation stage. Hence, in the operation of graph 403, utilizing an add first operation may not take advantage of the fast adders, such as in the example structure 404. Because the output goes through several ripple adders, this operation may wait for carry generation from the previous stage, thereby resulting in a serial operation instead of the parallel operation, such as in the graph 402.

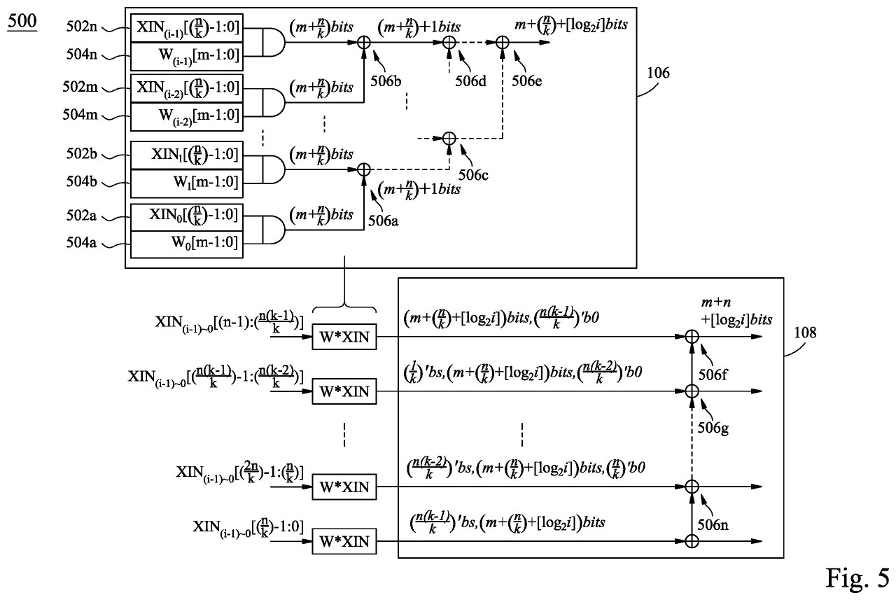

Referring to FIG. 5, depicted is an example logic structure 500 for accumulating partial products and performing shift and add to obtain an output for the shift last MAC process, in accordance with some embodiments. The logic structure 500 includes blocks 106 and 108, as implemented using any of the components, devices, or circuits detailed herein in conjunction with FIG. 1, such as the processing circuit 102. In various other implementations, the operations of FIG. 5 can be performed by other components or devices thereof, not limited to FIG. 1. The operations of blocks 106 and 108 of the logic structure 500 can be described in conjunction with at least one of FIGS. 1-4. In various implementations, the operations of blocks 106 and/or 108 of FIG. 5 can be applied similarly to or used for the operations of FIG. 4. For example, FIG. 5 can provide a relatively higher level overview of the operations of blocks 106 and/or 108 of but not limited to FIG. 4. As described in conjunction with, but not limited to FIG. 4, the inputs 502a-n of FIG. 5 may include or correspond to XIN0-3, and weights 504a-n may include or correspond to W0-3. In another example, the ripple adders 506a-n may include or correspond to at least one of the ripple adders 407a-f of FIG. 4.

The logic structure 500 provides example formulas used for the operations of blocks 106 and 108. These example formulas can be applied or used for the operations described in

$$XIN ( e . g . , {XIN}_{( i - 1 )} [ ( \frac{n}{k} ) - 1 : 0 ] to {XIN}_{0} [ ( \frac{n}{k} ) - 1 : 0 ] )$$

conjunction with, but not limited to, at least one of FIGS. 1-4, for example. For example, can be broken into k bits (bit orders [k−1] to [0]) to produce different partial products (e.g., as input data 104 or as part of block 106). The “n” can represent the number of bits in XIN. The processing circuit 102 can accumulate the partial products to generate k partial product sums of

$$m + ( \frac{n}{k} ) + ⌈ {log}_{2} i ⌉ bits$$

(at block 106), where i represents the number of bits of the initial binary numbers. The ┌log₂ i┐ can denote the ceiling function of log₂ i. At block 108, the processing circuit 102 can shift and add the k partial product sums to generate a final output (e.g., the output data 110) of the shift last MAC process. The signed extension can be denoted as x′bs and the unused bits can be denoted as y′b0 (unused bit y times). For example, the processing circuit 102 can perform the shift and add operation for summing

$${( \frac{n ( k - 1 )}{k} )}^{′} bs , ( m + ( \frac{n}{k} ) + ⌈ {log}_{2} i ⌉ ) bits , {( \frac{n ( k - 2 )}{k} )}^{′} bs , ( m + ( \frac{n}{k} ) + ⌈ {log}_{2} i ⌉ ) bits , {( \frac{n}{k} )}^{′} b … , {( \frac{1}{k} )}^{′} bs , m + ( \frac{n}{k} ) + ⌈ {log}_{2} i ⌉ ) bits , {( \frac{n ( k - 2 )}{k} )}^{′} b 0 , and ( m + ( \frac{n}{k} ) + ⌈ {log}_{2} i ⌉ ) bits , {( \frac{n ( k - 1 )}{k} )}^{′} b 0.$$

In this case, the final output can be represented as m+n+┌log₂ i┐ bits. The formulas/logic of the logic structure 500 can be used for at least blocks 106 and 108 as part of the operations performed by the processing circuit 102.

Referring to FIG. 6, depicted is an example process 600 of the calculation steps for the shift last MAC process, in accordance with some embodiments. The example process 600 can be implemented or performed using any of the components, devices, or circuits detailed herein in conjunction with FIG. 1, such as the processing circuit 102. In various other implementations, the example process 600 can be performed by other components or devices thereof, not limited to FIG. 1. The example process 600 involves a shift last MAC process for 3-bit inputs, including XIN0, XIN1, XIN2, W0, W1, and W2.

Referring to block 106, the processing circuit 102 can generate the partial products by multiplying all bits of XIN with individual bits of W. As shown in operation (602), the processing circuit 102 multiplies bits of XIN0 by bit[0] of W0 to generate ‘100’ (PP0), bit[1] of W0 to generate ‘100’ (PP1), and bit[2] of W0 to generate ‘000’ (PP2), respectively. The processing circuit 102 multiplies all bits of XIN1 by each bit order of W1 to generate ‘011’ (PP3), ‘000’ (PP4), and ‘101’ (PP5), respectively. The processing circuit 102 multiplies all bits of XIN2 by each bit order of W2 to generate ‘000’ (PP6), ‘000’ (PP7), and ‘101’ (PP8), respectively. For example, for two's complement multiplication, the last partial product can be a two's complement. These partial products PP0-PP8 can be grouped based on the corresponding bit position of W used to obtain the respective partial products. For example, PP0, PP3, and PP6 can be grouped because bit[0] of W is used to obtain these partial products. In another example, PP1, PP4, and PP7 can be grouped because bit[1] of W is used to obtain these partial products. Further, PP2, PP5, and PP8 can be grouped because bit[2] is used to obtain these partial products. In this case, the summation or accumulation of partial products performed in block 106 corresponds to the accumulation of each respective group of partial products (e.g., grouping based on bit order used to obtain the respective partial products).

Still referring to operation (602) from block 106, the processing circuit 102 can add the partial products according to the bit order. For example, the processing circuit 102 can add PP0, PP3, and PP6 associated with bit order [0] to generate S0 (e.g., first partial product sum). The processing circuit 102 can add PP1, PP4, and PP7 associated with bit order [1] to generate S1 (e.g., second partial product sum). The processing circuit 102 can add PP2, PP5, and PP8 associated with bit order [2] to generate S2 (e.g., third partial product sum). For example, for two's complement multiplication, the last partial product can be a two's complement. The output from block 106 can be one of the inputs for block 108.

At operation (604) associated with block 108, the processing circuit 102 can perform the shift and add operations using the partial product sums. For example, the processing circuit 102 shifts S1 by one bit position (to the left). The processing circuit 102 adds S0 with the shifted S1 to obtain S_MID1. The processing circuit 102 also shifts S2 by two bit positions, since S2 is associated with bit order [2]. The processing circuit 102 adds S_MID1 with the shifted S2 to generate the output data 110 (e.g., labeled as SUM in this example). The processing circuit 102 can utilize at least one fast adder (e.g., simplified CSA, CLA, etc.) to perform the shift and add operations. In this case, the processing circuit 102 may utilize a ripple adder (e.g., 6-bit ripple adder) and the simplified CSA for the summation of S_MID1 and S2, although the simplified CLA or other types of fast adders can be utilized herein for the summation. Similar types of summation can be applied for the summation of S0 and S1, for example, the simplified CSA and/or the simplified CLA may be used for the summation of S0 and S1.

For example, at operation (604) for summing S_MID1 and S2, the first two binary numbers (e.g., A[1:0]) of S_MID1 can be transferred to the results, such as part of the output data 110, since S2 is shifted by two bit positions (e.g., A[1:0]+0=A[1:0]). The processing circuit 102 can use the ripple adder to sum a portion of S_MID1 and S2 (e.g., from the third bit position to the third from the last bit position), in this case, the summation of S_MID1[5:2] and S2[5:2]. The processing circuit 102 can use the simplified CSA to generate an output for the last two bits of the result (e.g., the last two bits for the output data 110). These last two bits are pre-computed, which can be selected based on the signed bit and the carry bit. For instance, if the signed bit is 1 and the carry bit is 0, the resulting pre-computed last two can be 2′b1+2′b1. If the signed bit is 0 and the carry bit is 1, the resulting pre-computed last two can be 2′b1+1′b1. If the signed bit is 0 and the carry bit is 0 or if the signed bit is 1 and the carry bit is 1, the resulting pre-computed last two can be 2′b1(+0). The output from the simplified CSA and the ripple adder of the operation (604) can correspond to the output of block 108, for example.

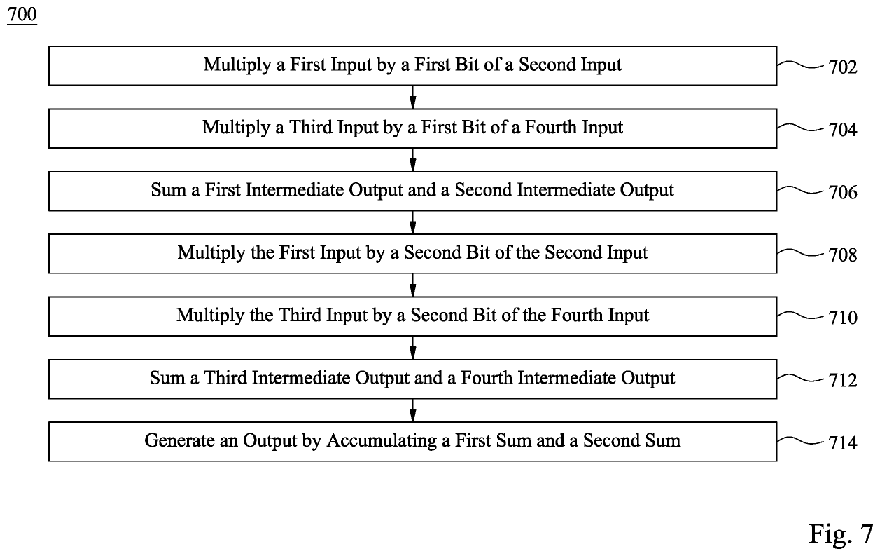

Referring to FIG. 7, depicted is an example flow chart of a method 700 for shift last MAC process, in accordance with some embodiments. The method 700 may be implemented using any of, but not limited to, the components and devices detailed herein in conjunction with FIGS. 1-6. In various other implementations, the example method 700 can be performed by other components or devices thereof, not limited to FIG. 1. The method 700 uses 2-bit inputs as an example for the shift last MAC process, although other numbers of bits can be used as inputs, such as 3-bit inputs, 4-bit inputs, 6-bit inputs, 10-bit inputs, etc. In overview, the method 700 can include generating intermediate outputs (e.g., partial products) of a first input to a fourth input, summing the intermediate outputs according to or based on the order of bit used to generate the partial products, and generating an output by accumulating the summed intermediate outputs (e.g., shift and add at the last stage of the MAC process).

At operation (702), a processing circuit (e.g., processing circuit 102, logic device, or circuit) can multiply a first input by a first bit of a second input to obtain a first intermediate output, such as but not limited to using the AND logic gates 406 of FIG. 4. The inputs can correspond to binary numbers. The first input and the second input can be a group/pair/set of inputs (e.g., inputs of the same i term) to be multiplied and accumulated. The first bit can refer to an order of bit at a first position (or a first order of bit), such as bit order [0]. For simplicity, the bit order can start from LSB to MSB, although in some other examples, the bit order can start from MSB to LSB. At operation (704), the processing circuit can multiply a third input by a first bit of a fourth input to obtain a second intermediate output, such as but not limited to using another one of the AND logic gates 406 of FIG. 4. At operation (706), the processing circuit can sum the first intermediate output and the second intermediate output to obtain a first sum (e.g., the first partial product sum), such as but not limited to using at least one of the ripple adders 407a-c. In some implementations, the first intermediate output and the second intermediate output can refer to first (pair of) partial products associated with the first order of bit. The processing circuit can sum the first partial products to obtain the first sum.

Similarly, the processing circuit can use the second bit of the second input and the fourth input to generate the intermediate outputs or partial products associated with an order of bit at a second position (or a second order of bit), such as bit order [1]. For example, at operation (708), the processing circuit can multiply the first input by a second bit of the second input to obtain a third intermediate output, such as but not limited to using one of the AND logic gates 406. At operation (710), the processing circuit can multiply the third input by a second bit of the fourth input to obtain a fourth intermediate output, such as but not limited to using another one of the AND logic gates 406. At operation (712), the processing circuit can sum the third intermediate output and the fourth intermediate output to obtain a second sum, such as but not limited to using one of the ripple adders 407a-c.

In some implementations, the third intermediate output and the fourth intermediate output can refer to second (pair of) partial products associated with the second order of bit. The processing circuit can sum the second partial products to obtain the second sum. In some implementations, the first intermediate output and the third intermediate output are partial products of the first input and the second input, and the second intermediate output and the fourth intermediate output are partial products of the third input and the fourth input.

At operation (714), the processing circuit can generate an output of the shift last MAC process by accumulating/summing the first sum and the second sum, such as but not limited to using one of the ripple adders 407e-f (with fast adders, such as simplified CSA or simplified CLA, among others). To accumulate the first sum and the second sum, the processing circuit can apply or perform a shift the second sum. For example, the processing circuit can shift the second sum according to the order of bit used to generate or obtain the third intermediate output, fourth intermediate output, and/or the second sum. In this example, the second sum is associated with an order of bit [1], hence, the processing circuit can shift the second sum (e.g., bits) by one bit position to the left. Responsive to shifting the second sum, the processing circuit can accumulate the first sum and the shifted second sum to obtain the output. The processing circuit performs the shift as part of the MAC process, for instance, after the multiplication step/operation between the first to fourth inputs (e.g., to obtain the partial products or intermediate outputs).

In various implementations, the processing circuit can use or perform ripple carry adders (e.g., ripple adders) to add two binary numbers. For example, the processing circuit can perform at least one of: a ripple carry adder on the first intermediate output and the second intermediate output to obtain the first sum, a ripple carry adder on the third intermediate output and the fourth intermediate output to obtain the second sum, and/or at least one of a ripple carry adder and/or a simplified CSA on the first sum and the shifted second sum to generate the output.

In various implementations, the processing circuit can perform a fast adder for the shift and add operations, such as when shifting the second sum and adding the first sum to the shifted second sum. In some configurations, the processing circuit can perform a CSA operation on the first sum and the shifted second sum to generate the output. In some other configurations, the processing circuit can perform a CLA operation on the first sum and the shifted second sum to generate the output. In further configurations, the processing circuit may perform other types of fast adders to perform the shift and add operations. The generated output from the processing circuit can include a signed bit. In some cases, one or more inputs for the MAC process can be signed binary numbers.

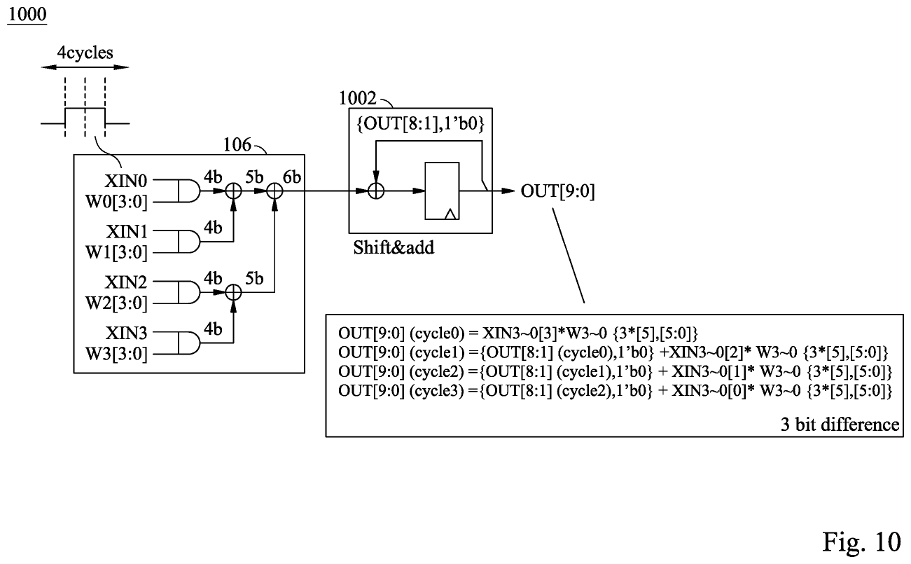

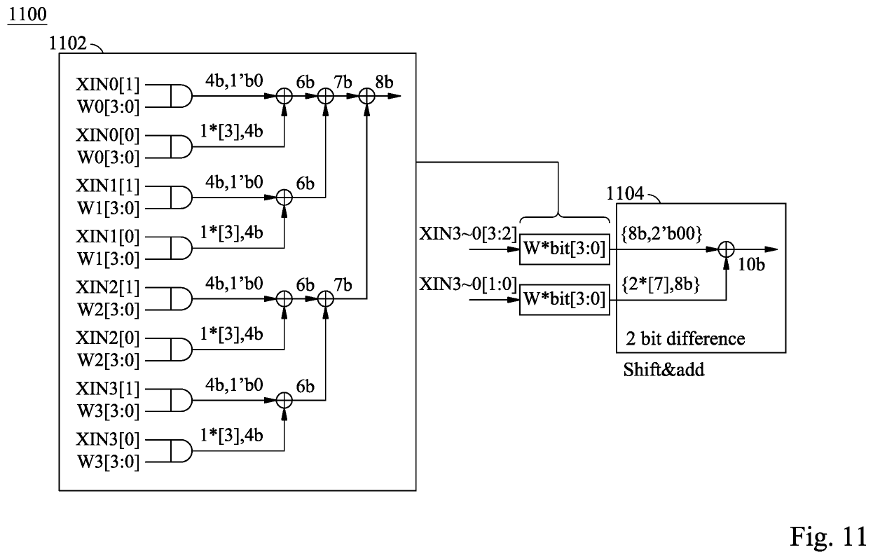

Referring to FIG. 8, depicted is an example of a summation 800 using a simplified CSA and/or a simplified CLA, in accordance with some embodiments. In various implementations, the summation 800 can be performed or implemented using any of the components, devices, or circuits detailed herein in conjunction with FIGS. 1-6, such as the processing circuit 102. In various other implementations, the summation 800 can be performed by other components or devices thereof, not limited to FIG. 1. As shown, the summation 800 is performed between two binary numbers, such as a first binary number 802 (e.g., labeled as “A”) and a second binary number 804 (e.g., labeled as “B”). Each of the binary numbers includes “m” total number of bits. In some cases, the binary numbers to be summed may include different total numbers of bits. For simplicity and for purposes of providing examples herein, each binary number (e.g., the first binary number 802 and the second binary number 804) can include the same number of bits. In some implementations, the summation 800 can be performed in conjunction with, in addition to, or alternatively to the summation operation 202 of at least one of FIGS. 2-3, for example. The summation 800 can be performed for the shift and add operations, such as in block 108 of at least one of FIGS. 4-6, operation 1002 of FIG. 10, and/or operation 1104 of FIG. 11, for example. Although the summation 800 (between binary numbers) can be performed using the simplified CSA, such as described in conjunction with at least FIGS. 9-11, similar summation between binary numbers can be performed using the simplified CLA, among other fast adder techniques.

In some implementations, to perform the summation of two binary numbers, such as the summation/addition of two partial products discussed herein, one of the binary numbers may be shifted prior to the summation (e.g., performing a shift and add operation to sum the partial products associated with respective different bit positions of the input). In this example, the summation 800 is performed when the second binary number 804 is shifted by n bits, where n represents the total number of bit positions being shifted. As shown, the second binary number 804 shifts left by n bits (e.g., n number of bit positions).

When shifting the second binary number 804, the processing circuit 102 is configured to provide, insert, or generate one or more signed extension bits 806, such that the total number of bits of the two binary numbers are the same. For example, because the first binary number 802 and the second binary number 804 include m bits, the processing circuit 102 can provide n number of signed extension bits 806 corresponding to the shifting of the second binary number 804 by n bits. The “m” corresponds to the number of bits of the binary number (e.g., the original binary number). Hence, when shifting the second binary number 804 by n bits, the corresponding n number of signed extension bits 806 is provided, inserted, or generated for the first binary number 802. Each of the one or more signed extension bits 806 corresponds to the MSB of the first binary number 802. In this case, the MSB of the binary number is a signed bit (e.g., a bit indicative of negative or positive value for the binary number). For example, if the MSB of the first binary number 802 is ‘1’, all signed extension bits 806 are ‘1’, and if the MSB of the first binary number 802 is ‘0’, all signed extension bits 806 are ‘0’.

As shown in FIG. 8, after shifting one of the binary numbers and inserting at least one signed extension bit for the other binary number, the bit positions of the binary numbers can be separated into three portions as referred to and discussed herein. For example, the summation 800 includes portions 808, 810, and 812, where each portion corresponds to respective one or more bit positions. The portion 808 corresponds to the at least one bit position of the at least one signed extension bit. In this case, portion 808 of the second binary number 804 corresponds to the bit positions of the signed extension bits 806 of the first binary number 802. The bit position(s) of the second binary number 804 in portion 808 may be referred to as the bit position(s) that overlaps with or is associated with the signed extension bit(s). As shown, the portion 808 includes n bits of the second binary number 804 and the n signed extension bits of the first binary number 802. The portion 808 of the second binary number 804 can be used as inputs (e.g., pre-computed results) for, but not limited to, the MUX 906 of FIG. 9, such as part of the simplified CSA, for example.

The portion 810 corresponds to one or more bit positions that include a subset of the m bits of the first binary number 802 and the second binary number 804 (e.g., an overlapping portion of the original binary numbers). As shown, the portion 810 includes the remaining bits of the second binary number 804 (excluding the n-bits associated with portion 808), and a portion of the first binary number 802 (e.g., excluding the unused n-bits of A). This portion 810 can be used as inputs for the ripple adder 902 of FIG. 9, for example. In this case, the portion of the first binary number 802 includes one or more bit positions from the MSB of the first binary number 802 to the bit position corresponding to the LSB of the second binary number 804.

The portion 812 corresponds to one or more bit positions that are unused for the summation of the first binary number 802. For example, by shifting the second binary number 804 n bits to the left, there is an n number of unused bits of the first binary number 802, such as a sum of the portion of the first binary number 802 and zero. Hence, as described in conjunction with, but not limited to, at least one of FIGS. 2-3, the processing circuit 102 is configured to use the portion 812 of the first binary number 802 as part of the output (e.g., no summation is performed on the portion 812, such that the unused n-bits of A corresponds to the resulting n-bits of S of FIGS. 2-3).

Because the first binary number 802 includes an unused bits (e.g., portion 812), the length (e.g., bit length or bit width) of the first binary number 802 to be summed with the second binary number 804 is (m-n) bits (e.g., portion 810, excluding the signed extension bits). In various implementations, the processing circuit 102 is configured to pre-compute the output (e.g., predictable output) for the summation of the binary numbers at portion 808 to reduce the carry propagation time. The output of portion 808 can be pre-computed because all signed extension bits of the first binary number 802 are the same as the MSB of the first binary number 802 (e.g., repeats or copies of the MSB by n times). The processing circuit 102 is configured to perform the pre-computation as a part of the simplified CSA, for example.

Referring to FIG. 9, depicted is an example block diagram of a process 900 to compute a sum between two binary numbers (e.g., first binary number 802 and second binary number 804) using the simplified CSA, in accordance with some embodiments. In various implementations, the process 900 can be performed or implemented using any of the components, devices, or circuits detailed herein in conjunction with FIGS. 1-6, such as the processing circuit 102. In various other implementations, the process 900 can be performed by other components or devices thereof, not limited to FIG. 1. For simplicity and for purposes of providing examples herein, the first binary number 802 is denoted as “A” and the second binary number 804 is denoted as “B”, such that each of the A and B includes m bits, B is shifted by n bits, and A includes n signed extension bits. Although the simplified CSA can be used for the process 900, in some cases, the simplified CLA, or other similar adders, may be used for the process 900, for example. Hence, in some configurations, the process 900 can be used in conjunction with or in place of the process 200 or the process 300, or other shift and add operations, for example.

In some implementations, the process 900 can be associated with the operation 202. In some implementations, the process 900 can be comparative to the process 300 of FIG. 3. For example, compared to the process 300 of FIG. 3, the process 900 of FIG. 9 is performed for adding binary numbers with m number of bits, where one of the binary numbers is shifted by n number of bits to generate m+n bit binary number as the output, for instance, not limited to, the 10-bit output of FIG. 3. In another example, the process 900 of FIG. 9 shows the pre-computed inputs for the MUX 906 (e.g., B[(m−1):(m−n)]+n′b1, B[(m−1):(m−n)]+1′b1, and B[(m−1):(m−n)]) to provide an output (e.g., S[(m+n−1):m]) based on the SEL (e.g., select signal) from the select decoder logic 904. The process 900 including the pre-computed inputs may be performed in conjunction with, but not limited to, the process 300 of FIG. 3, among other operations.

The process 900 can include at least one ripple adder 902, at least one select decoder logic 904, and at least one multiplexer (MUX) 906. The processing circuit 102 can use the ripple adder 902 to compute a sum between at least one portion of A and B (e.g., portion 810 of the first binary number 802 and the second binary number 804). For example, the processing circuit 102 can provide A[m−1:n] and B[m−n−1:0] as inputs to the ripple adder 902. The m denotes the number of bits associated with the binary numbers A and B. The (m−1) denotes or represents the MSB of A or B. In the case of B, the (m−n−1) denotes a bit position of B that corresponds to the MSB position of A. As described in conjunction with FIG. 8, A[m−1:n] represents portion 810 of A, and B[m−n−1:0] represents portion 810 of B. The processing circuit 102 is configured to compute the sum of A and B at portion 810 using the ripple adder (or other types of adders) to generate an output S[m−1:n], where “S” denotes the sum of A and B. In this example, the output of the ripple adder includes bit positions (m−1) to n because the processing circuit 102 can provide the unused n bits of A (e.g., at portion 812) as part of the output without summation with B. For instance, at this stage, the output of the sum of two binary numbers includes bits S[m−1:n] and A[n−1:0].

As discussed herein, because all the signed extension bits are the same as each other (e.g., corresponding to the MSB of A), the processing circuit 102 can be configured with predetermined (e.g., predictable) output combinations. The predetermined output combinations can refer to different combinations of input values (e.g., MSB of A and the carry bit of the ripple adder 902) that are associated with respective pre-computed values to be outputted by the MUX 906. These pre-computed values are provided as inputs to the MUX 906, where one of the pre-computed values is to be selected by the select decoder logic 904 for output by the MUX 906.

In some cases, the processing circuit 102 can compute the pre-computed values before the select decoder logic 904 receives the input values from the ripple adder 902. The processing circuit 102 can compute the pre-computed values prior to, concurrent to, or after executing the ripple adder 902.

The select decoder logic 904 is configured to select one of the states associated with the predetermined output combinations using a logic truth table 908. The select decoder logic 904 is configured to output the selected state from the logic truth table 908 based on the MSB of A and the carry bit from the ripple adder 902. The logic truth table 908 indicates which state (or predetermined output combination) to select based on the inputs from the ripple adder 902. For example, if the MSB of A and the carry bit are both ‘0’ or are both ‘1’, the select decoder logic 904 is configured to select a first state “S0”. As shown in the logic truth table 908, the S0 state corresponds to MUX 906 output of B[(m−1):(m−n)], which represents the bits at portion 808 of B. In the case that the inputs are ‘0’, the MUX 906 is configured to output B[(m−1):(m−n)] because the signed extension bits are ‘0’ (e.g., corresponding to the MSB of A) and the carry bit is ‘0’. Hence, the bit(s) of B associated with or overlapped with the signed extension bits of A are summed by zero. In the cases that the inputs are ‘1’, the MUX 906 is configured to output B[(m−1):(m−n)] because the signed extension bits are ‘1’ (e.g., corresponding to the MSB of A) and the carry bit is ‘1’. Hence, when the carry bit is added to the signed extension bits of all ‘1’, the result is bit ‘1’ as the MSB and ‘0’ for the remaining bits, which is equal to zero in the signed number.

In another example, if the MSB of A is ‘0’ and the carry bit is ‘1’, the select decoder logic 904 is configured to select a second state “S1”. As shown in the logic truth table 908, the S1 state corresponds to MUX 906 output of B[(m−1):(m−n)]+1 (or 1′b1) associated with the carry bit. In this case, because the MSB of A is ‘0’, all signed extension bits of A associated with portion 808 of B are zero. Hence, the sum of A and B at portion 808 is B[(m−1):(m−n)]+1 (e.g., the carry bit).

In yet another example, if the MSB of A is ‘1’ and the carry bit is ‘0’, the select decoder logic 904 is configured to select a third state “S2”. As shown in the logic truth table 908, the S2 state corresponds to MUX 906 output of B[(m−1):(m−n)]+n′b1, where n′b1 represents n number of signed bits of ‘1’. In this case, because the MSB of A is ‘1’, all signed extension bits of A associated with portion 808 of B are ‘1’. Hence, the sum of A and B at portion 808 is B[(m−1):(m−n)]+n′b1 associated with the signed extension bits of ‘1’. Responsive to the selection of the state, the select decoder logic 904 is configured to output the state to the MUX 906.

The MUX 906 is configured to select one of the inputs (e.g., pre-computed values) to provide as an output for the simplified CSA according to the selected state from the select decoder logic 904. As shown, the MUX 906 is configured to output one of the B[(m−1):(m−n)], B[(m−1):(m−n)]+1′b1, or B[(m−1):(m−n)]+n′b1 according to the MSB of A and the carry bit from the ripple adder 902, for example. The output of MUX 906 (e.g., corresponding to the output of the simplified CSA) is denoted as S[(m+n−1):m]. The (m+n−1) represents the bit position of the MSB of B after the shift of n bits. Responsive to obtaining the output from MUX 906, the processing circuit 102 is configured to generate the output of the sum of two binary numbers including bits S[m+n−1]:m], S[m−1:n], and A[n−1:0].

Referring to FIG. 10, depicted is an example bit serial MAC process 1000 using the simplified CSA, in accordance with some embodiments. In various implementations, the example process 1000 can be performed or implemented using any of the components, devices, or circuits detailed herein in conjunction with FIGS. 1-6, such as the processing circuit 102. In various other implementations, the example bit serial MAC process 1000 can be performed by other components or devices thereof, not limited to FIG. 1. As shown in FIG. 10, the simplified CSA can be used for the bit serial MAC process 1000, such as during the shift and add operation 1102. The example process 1000 is performed for four pairs of inputs (e.g., XIN3-0 and W3-0), where each input includes four bits (e.g., [3:0]), although process 1000 can be performed with more or fewer input pairs or the bits as discussed herein.

For example, in the bit serial MAC process 1000, each bit of XIN3-0[3:0] is input into the MAC in four consecutive cycles (e.g., similar to the operations of block 106). The number of cycles can correspond to the number of bits of the inputs. The output from each cycle is added to the output of the next/subsequent cycle of the bit serial MAC process 1000 via shift and add to perform the MAC operation. Because there are four cycles in this example, the processing circuit 102 can use the simplified CSA on the three shift and add operations 1102, among other similar operations. Responsive to executing the four cycles, in this example, there is a total of 3-bit difference from performing the shift and add operation 1002. The operations of process 900 can be used for the shift and add operation 1002, which can be similar to the operations of block 108, for example. Hence, the processing circuit 102 can perform the simplified CSA of process 900 for the 3-bit difference during the shift and add operation 1002 to reduce the carry propagation thereof.

Referring to FIG. 11, depicted is an example bit parallel MAC process 1100 using the simplified CSA, in accordance with some embodiments. In various implementations, the example process 1100 can be performed or implemented using any of the components, devices, or circuits detailed herein in conjunction with FIGS. 1-6, such as the processing circuit 102. In various other implementations, the example bit parallel MAC process 1100 can be performed by other components or devices thereof, not limited to FIG. 1. As shown in FIG. 11, the simplified CSA can be used for the bit parallel MAC process 1100, such as during the shift and add operation 1104. The example process 1100 is performed for four pairs of inputs (e.g., XIN3-0 and W3-0), where each input includes four bits (e.g., [3:0]), although process 1100 can be performed with more or fewer input pairs or the bits as discussed herein.

For example, in the bit parallel MAC process 1100, multiple bits of XIN3-0[3:0] are input into the MAC operation at the same time. As shown in block 1102, in this example, two bits of XIN3-0 are provided as inputs into the MAC operation. Hence, for 4-bit inputs, the processing circuit 102 is configured to perform the MAC operation for XIN3-0[3:2] in parallel with XIN3-0[1:0]. The output from these two MAC operations can be accumulated via the shift and add operation 1104. The processing circuit 102 can perform the simplified CSA as part of the shift and add operation 1104. Similarly to, for instance, the shift and add operation 1002, the operations of process 900 can be used for the shift and add operation 1104. The shift and add operation 1004 may be described similarly to the operations of block 108, for example. Hence, responsive to executing the shift and add operation 1104, there can be a 2-bit difference when the shift and add operation 1104 is performed for W×XIN3-0[3:2] and W×XIN3-0[1:0]. The processing circuit 102 can perform the simplified CSA for the 2-bit difference during the shift and add operation 1104, thereby reducing the carry propagation thereof.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, e.g., one or more components of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can include a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The terms “processing circuit,” “data processing apparatus”, “data processing system”, “computing platform”, “computing device”, or “device” encompasses all kinds of apparatus, devices, and machines for processing data, including by way of example a programmable processor, integrated circuit (IC), a computer, a system on a chip, or multiple ones, or combinations, of the foregoing. The apparatus can include special purpose logic circuitry, e.g., an FPGA (field programmable gate array) or an ASIC (application-specific integrated circuit). The apparatus may include, in addition to hardware, code that creates an execution environment for the computer program, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit). In various implementations, the processes and logic flows described herein can be performed by an IC containing hardware circuit devices or types of logic (e.g., logic components), including FPGAS, ASICs, logic gates, registers, or transistors, electrically or communicatively coupled/connected via various interconnections between the circuit devices.

Processors suitable for the execution of a computer program include, by way of example, both general and special purpose microprocessors, and any one or more processors of any kind of digital computer. Generally, a processor will receive instructions and data from a read-only memory or a random access memory or media. The elements of a computer include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions, configurations, or processes do not depart from the spirit and scope of the present disclosure, and that they may make various changes, substitutions, and alterations herein without departing from the spirit and scope of the present disclosure.

1. A method, comprising:
multiplying, by a processing circuit, a first input by a first bit of a second input to obtain a first intermediate output;
multiplying, by the processing circuit, a third input by a first bit of a fourth input to obtain a second intermediate output;
summing, by the processing circuit, the first intermediate output and the second intermediate output to obtain a first sum;
multiplying, by the processing circuit, the first input by a second bit of the second input to obtain a third intermediate output;
multiplying, by the processing circuit, the third input by a second bit of the fourth input to obtain a fourth intermediate output;
summing, by the processing circuit, the third intermediate output and the fourth intermediate output to obtain a second sum; and
generating, by the processing circuit, an output by accumulating the first sum and the second sum.

2. The method of claim 1, wherein accumulating the first sum and the second sum comprises:
shifting, by the processing circuit, the second sum; and
summing, by the processing circuit, the first sum and the shifted second sum to generate the output.

3. The method of claim 2, wherein shifting the second sum comprises:
shifting, by the processing circuit, the second sum according to an order of bit used to obtain the third intermediate output and the fourth intermediate output.

4. The method of claim 2, wherein the summation comprises at least one of:
performing, by the processing circuit, a ripple carry adder on the first intermediate output and the second intermediate output to obtain the first sum;
performing, by the processing circuit, a ripple carry adder on the third intermediate output and the fourth intermediate output to obtain the second sum; or
performing, by the processing circuit, at least one of a ripple carry adder or a simplified carry select adder (CSA) on the first sum and the shifted second sum to generate the output.

5. The method of claim 2, wherein summing the first sum and the shifted second sum comprises:
performing, by the processing circuit, at least one of a ripple carry adder or carry select adder (CSA) on the first sum and the shifted second sum to generate the output.

6. The method of claim 5, wherein performing the CSA comprises:
providing, by the processing circuit based on the shifting of the second sum, at least one signed extension bit to the first sum corresponding to a most significant bit (MSB) of the first sum; and
according to the MSB of the first sum and a carry bit from a ripple carry adder, at least one of:
determine, by the processing circuit, a first portion of the output based on a sum of at least one MSB of the second sum and the at least one signed extension bit, wherein the at least one MSB of the second sum is associated with a position of the at least one signed extension bit;
determine, by the processing circuit, a first portion of the output based on a sum of at least one MSB of the second sum and one, wherein the at least one MSB of the second sum is associated with a position of the at least one signed extension bit; or
determine, by the processing circuit, a first portion of the output based on at least one MSB of the second sum associated with a position of the at least one signed extension bit.

7. The method of claim 2, wherein summing the first sum and the shifted second sum comprises:
performing, by the processing circuit, a carry lookahead adder (CLA) on the first sum and the shifted second sum to generate the output.

8. The method of claim 1, wherein the generated output comprises a signed bit.

9. The method of claim 1, wherein the first intermediate output and the third intermediate output are partial products of the first input and the second input, and wherein the second intermediate output and the fourth intermediate output are partial products of the third input and the fourth input.

10. The method of claim 1, comprising:
summing, by the processing circuit, first partial products associated with a first order of bit to obtain the first sum;
summing, by the processing circuit, second partial products associated with a second order of bit to obtain the second sum; and
performing, by the processing circuit, a shift to the second sum for accumulating the first sum and the shifted second sum, wherein the shift is performed as part of a multiplication and accumulation (MAC) process after the multiplication between the first to fourth inputs.

11. A processing circuit, comprising:
a first circuit block configured to:
receive a first input, a second input, a third input, and a fourth input;
perform multiplication on the first input and the second input to obtain a first partial product and a second partial product;
perform multiplication on the third input and the fourth input to obtain a third partial product and a fourth partial product;
sum the first partial product and the third partial product to obtain a first sum; and
sum the second partial product and the fourth partial product to obtain a second sum; and
a second circuit block configured to:
receive the first sum and the second sum from the first circuit block; and
generate an output by accumulating the first sum and the second sum.

12. The processing circuit of claim 11, wherein to perform the multiplications, the first circuit block is configured to:
multiply the first input by a first bit of the second input to obtain a first intermediate output;
multiply the third input by a first bit of the fourth input to obtain a second intermediate output;
multiply the first input by a second bit of the second input to obtain a third intermediate output; and
multiply the third input by a second bit of the fourth input to obtain a fourth intermediate output.

13. The processing circuit for claim 12, wherein to perform the summations, the first circuit block is configured to:
sum the first intermediate output and the second intermediate output to obtain the first sum;
sum the third intermediate output and the fourth intermediate output to obtain the second sum; and
provide the first sum and the second sum to the second circuit block.

14. The processing circuit of claim 13, wherein to perform the summation, the first circuit block is configured to perform at least one of:
a ripple carry adder on the first intermediate output and the second intermediate output to obtain the first sum; or
a ripple carry adder on the third intermediate output and the fourth intermediate output to obtain the second sum.

15. The processing circuit of claim 11, wherein to accumulate the first sum and the second sum, the second circuit block is configured to:
shift the second sum; and
sum the first sum and the shifted second sum to generate the output.

16. The processing circuit of claim 15, wherein to shift the second sum, the second circuit block is configured to:
shift the second sum according to an order of bit used to obtain the second partial product and the fourth partial product.

17. The processing circuit of claim 15, wherein to perform the summation, the second circuit block is configured to:
perform a ripple carry adder on the first sum and the shifted second sum to generate the output.

18. The processing circuit of claim 15, wherein to perform the summation, the second circuit block is configured to:
perform a carry select adder (CSA) on the first sum and the shifted second sum to generate the output.

19. A processing circuit, comprising:
a first circuit block configured to:
receive a first input, a second input, a third input, and a fourth input;
multiply the first input by a first bit of the second input to obtain a first intermediate output;
multiply the third input by a first bit of the fourth input to obtain a second intermediate output;
sum the first intermediate output and the second intermediate output to obtain a first sum;
multiply the first input by a second bit of the second input to obtain a third intermediate output;
multiply the third input by a second bit of the fourth input to obtain a fourth intermediate output; and
sum the third intermediate output and the fourth intermediate output to obtain a second sum; and
a second circuit block configured to:
receive the first sum and the second sum from the first circuit block; and
generate an output by accumulating the first sum and the second sum.

20. The processing circuit of claim 19, wherein to accumulate the first sum and the second sum, the second circuit block is configured to:
shift the second sum according to an order of bit used to obtain the third intermediate output and the fourth intermediate output; and
sum the first sum and the shifted second sum to generate the output.
